(19) United States
(12) Patent Application Publication
(10) Pub. No.: US 2004/0261943 A1
(43) Pub. Date: Dec. 30, 2004

(54) Adhesive material, method for unsticking adhesive material and bound structure

(76) Inventors: Masateru Fukuoka, Osaka (JP); Munehiro Hatai, Osaka (JP); Yasuhiko Oyama, Osaka (JP); Shigeru Danjo, Osaka (JP); Satoshi Hayashi, Osaka (JP); Kazuhiro Shimomura, Saitama (JP); Tsuyoshi Hasegawa, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/495,515

(22) PCT Filed: Nov. 15, 2002
(86) PCT No.: PCT/JP02/11919

(30) Foreign Application Priority Data
Nov. 15, 2001 (JP) 2001350860

(51) Int. Cl. B32B 1/00

(52) U.S. Cl. 156/344

(57) ABSTRACT

An object of the present invention is to provide an adhesive substance capable of being easily peeled off without using light and damaging an adherend, a method for peeling off the adhesive substance, and a connected structure.

The present invention relates to an adhesive substance, which contains a gas-generating agent for generating gas by giving stimulation via an ultrasonic wave and/or impact thereto, generated gas being discharged to the outside of the adhesive substance and discharged gas peeling part of an adhesive surface off an adherend.

### TECHNICAL FIELD

The present invention relates to an adhesive substance capable of being easily peeled off without damaging an adherend, a method for peeling off an adhesive substance, and a connected structure.

### BACKGROUND ART

Nowadays, adhesive substances have been widely used for a binder agent such as an adhesive, a sealing agent, a paint and a coating material, a pressure-sensitive adhesive such as a pressure-sensitive adhesive tape and a self-supporting tape, and the like. The performances required for these adhesive substances vary with uses thereof, and some uses require that the adhesive substances exhibit adhesive property only while required and however can be easily peeled off thereafter.

For example, in the manufacturing process of IC chips, it has been proposed that a thick-film wafer is reinforced by adhering to a support plate to thereby advance the work efficiently, in the case where the thick-film wafer cut out of high-purity stick-shaped silicon single crystal is polished to a predetermined thickness into a thin-film wafer. Then, it is required that the adhesive substances between the thick-film wafer and the support plate stick them together firmly during the polishing process and, meanwhile, allows the obtained thin-film wafer to be peeled off the support plate without damaging after the polishing process.

A method for peeling off the adhesive substances is, for example, thought to peel off by applying physical force; however, this method has the possibility of bringing serious damage in the case where an adherend is weak.

In addition, a method for peeling off the adhesive substances by using a solvent for dissolving them is conceivable; however, this method can not be employed in the case where an adherend is deteriorated by the solvent.

Thus, there is a problem that a firmer adhesive strength of the adhesive substances once used for adhering makes it more difficult to peel off without damaging an adherend.

By contrast, a method for peeling off the adhesive substances by using light has been proposed. This method comprises such that a gas-generating agent for generating gas through decomposition by light is previously contained in the adhesive substances to peel part of an adhesive surface off an adherend by gas discharged through the irradiation of light on the occasion of peeling off the adhesive substances.

However, in the case where an adherend is an opaque material or a material which does not sufficiently transmit light in a wavelength range for generating gas from a gas-generating agent so that an adhesive surface can not be sufficiently irradiated with light in a wavelength range for generating gas from a gas-generating agent, the problem is that the incapability of employing a method for peeling off the adhesive substances by using light makes it difficult to peel off without damaging an adherend.

### SUMMARY OF THE INVENTION

In consideration of the above-mentioned circumstances, an object of the present invention is to provide an adhesive substance capable of being easily peeled off without using light and damaging an adherend, a method for peeling off the adhesive substance, and a connected structure.

The present invention is directed to an adhesive substance, which contains a gas-generating agent for generating gas by giving stimulation via an ultrasonic wave and/or impact thereto, generated gas being discharged to the outside of the adhesive substance and discharged gas peeling part of an adhesive surface off an adherend.

The adhesive substance of the present invention preferably has tan δ which is decreased by giving stimulation via an ultrasonic wave and/or impact or stimulation except the above-mentioned stimulation, and more preferably contains a component crosslinkable by giving stimulation via an ultrasonic wave and/or impact or stimulation except the above-mentioned stimulation.

The adhesive substance of the present invention may exhibit a pressure-sensitive adhesive property at normal temperature at least before giving stimulation via an ultrasonic wave and/or impact or stimulation except the above-mentioned stimulation, or may not exhibit a pressure-sensitive adhesive property at normal temperature.

The present invention is also directed to a method for peeling off an adhesive substance, which comprises giving stimulation to an adhesive substance containing a gas-generating agent for generating gas by giving stimulation via an ultrasonic wave and/or impact to generate gas from a gas-generating agent, and discharging generated gas to the outside of said adhesive substance.

The present invention is also directed to a connected structure, which is obtainable by bonding at least two or more adherends bonded together via an adhesive substance containing a gas-generating agent for generating gas by stimulation via an ultrasonic wave and/or impact.

### DETAILED DISCLOSURE OF THE INVENTION

Hereinafter, the present invention will be described in detail.

An adhesive substance of the present invention contains a gas-generating agent for generating gas by giving stimulation via an ultrasonic wave and/or impact thereto. The use of these stimulations allows gas to be generated from the gas-generating agent even in the case where an adherend is an opaque material and joined so that an adhesive surface can not be sufficiently irradiated with light.

Incidentally, an adhesive substance in the present specification denotes a substance having adhesive property in a state of being applied to an adherend, and is not particularly limited as long as it is a substance exhibiting the property of adhering to at least a surface to adhere to.

The above-mentioned stimulation via an ultrasonic wave and/or impact may be given from any direction. In addition, these stimulations are preferably given continuously until an adhesive surface is peeled off. In addition, the heating even at a lower temperature than the temperature at which gas is generated from a gas-generating agent allows gas to be efficiently generated in giving an ultrasonic wave and/or impact.

The above-mentioned gas-generating agent is not particularly limited as long as it generates gas by giving stimulation via an ultrasonic wave and/or impact thereto, and examples thereof may include an azo compound, an azide compound and the like. In particular, an azo compound is appropriate as the above-mentioned gas-generating agent.

The above-mentioned azide compound once starts to decompose by giving impact thereto and causes a chain reaction to explosively discharge nitrogen gas beyond control, whereby an adherend is damaged by the explosively discharged nitrogen gas in some cases.

The above-mentioned azo compound, unlike the azide compound, does not cause a chain reaction to explosively generate gas and, thereby, does not damage an adherend so as to be particularly appropriate for the case of peeling an adhesive substance off a weak adherend.

Examples of the above-mentioned azo compound may include 2,2′-azobis-(N-butyl-2-methyl propionamide), 2,2′-azobis{2-methyl-N-[1,1-bis(hydroxymethyl)-2-hydroxyethyl]propionamide}, 2,2′-azobis{2-methyl-N-[2-(1-hydroxybutyl)]propionamide}, 2,2′-azobis[2-methyl-N-(2-hydroxyethyl)propionamide], 2,2′-azobis[N-(2-propenyl)-2-methyl propionamide], 2,2′-azobis(N-butyl-2-methyl propionamide), 2,2′-azobis(N-cyclohexyl-2-methyl propionamide), 2,2′-azobis[2-(5-methyl-2-imidazoline2-yl)propane]dihydrochloride, 2,2′-azobis[2-(2-imidazoline2-yl)propane]dihydrochloride, 2,2′-azobis[2-(2-imidazoline2-yl)propane]disulfate dihydrolate, 2,2′-azobis[2-(3,4,5,6-tetrahydropyrimidine-2-yl)propane]dihydrochloride, 2,2′-azobis{2-[1-(2-hydroxyethyl)-2-imidazoline2-yl]propane}dihydrochloride, 2,2′-azobis[2-(2-imidazoline2-yl)propane], 2,2′-azobis(2-methyl propionamidine)dihydrochloride, 2,2′-azobis(2-aminopropane)dihydrochloride, 2,2′-azobis[N-(2-carboxyacyl)-2-methyl-propionamidine], 2,2′-azobis{2-[N-(2-carboxyethyl)amidine]propane}, 2,2′-azobis(2-methyl propionamide oxime), dimethyl2,2′-azobis(2-methyl propionate), dimethyl2,2′-azobisisobutyrate, 4,4′-azobis(4-cyanocarbonic acid), 4,4′-azobis(4-cyanopentanoic acid), 2,2′-azobis(2,4,4-trimethylpentane), and the like.

Examples of the above-mentioned azide compound may include 3-azide methyl-3-methyl oxetane, terephthalazide, para-tert-butylbenzazide; a polymer having an azide group such as a glycidyl azide polymer obtained by the ring-opening polymerization of 3-azide methyl-3-methyl oxetane, and the like.

In the case of performing adhesion by using an adhesive substance of the present invention, gas generated from a gas-generating agent is discharged by giving stimulation via an ultrasonic wave and/or impact to an adhesive surface, and then the generated gas is discharged to the outside of the adhesive substance, so that the discharged gas peels a part of the adhesive surface off an adherend to decrease adhesive strength, whereby the adherend can be easily peeled off. On this occasion, it is preferable that the gas generated from the gas-generating agent is totally discharged to the outside of the adhesive substance and does not exist in the adhesive substance. Even in this case, however, a part of the generated gas may exist as air bubbles in the adhesive substance unless it is made into foams for adhesive deposit.

Preferably, the above-mentioned adhesive substance is a substance such that tan δ is decreased by giving stimulation via an ultrasonic wave and/or impact or stimulation except the above-mentioned stimulation. In particular, an adhesive substance containing a component crosslinkable by giving stimulation via an ultrasonic wave and/or impact or stimulation except the above-mentioned stimulation is more preferable.

Incidentally, the above-mentioned tan δ is calculated on the basis of elastic modulus in measuring dynamic viscoelasticity using a viscoelasticity measuring device, and the decrease of tan δ signifies that the adhesive substance loses elasticity to harden and thus pressure-sensitive adhesive strength of the adhesive substance is decreased.

Examples of the above-mentioned substance such that tan δ is decreased by giving the stimulation may include a substance which contains a component crosslinkable by giving stimulation via humidity, heat, chemical reaction, light and ultrasonic wave, and thereby is cured or crosslinked by giving stimulation via humidity, heat, chemical reaction, light and ultrasonic wave so that tan δ is decreased; a substance such that tan δ is decreased by phase change from liquid matter to solid matter with the volatilization of a solvent; a substance such that tan δ is decreased by passing electric current; resin having Tg in the vicinity of normal temperature; and the like.

Incidentally, light in the present specification includes not only infrared rays, visible rays and ultraviolet rays but also ionizing radiation such as electron rays, X-rays and neutron radiation.

Examples of the above-mentioned substance such that tan δ is decreased by giving stimulation via humidity may include humidity-curing adhesive resin such as a humidity-curing adhesive, a humidity-curing pressure-sensitive adhesive and a humidity-curing sealing agent.

Examples of the above-mentioned substance such that tan δ is decreased by giving stimulation via heat may include thermosetting adhesive resin such as a thermosetting adhesive, a thermosetting pressure-sensitive adhesive and a thermosetting sealing agent.

Examples of the above-mentioned adhesive substance such that tan δ is decreased by giving stimulation through chemical reaction may include two component curing adhesive resin such as a two component curing adhesive, a two component curing pressure-sensitive adhesive and a two component curing sealing agent, and anaerobic-curing adhesive resin such as an anaerobic-curing adhesive, an anaerobic-curing pressure-sensitive adhesive and an anaerobic-curing sealing agent.

Examples of the above-mentioned adhesive substance such that tan δ is decreased by giving stimulation via light may include photo-curing adhesive resin such as a photo-curing adhesive agent, a photo-curing pressure-sensitive adhesive and a photo-curing sealing agent.

Examples of the above-mentioned photo-curing adhesive resin may include a resin mainly including an acrylic acid alkyl ester and/or methacrylic acid alkyl ester polymerizable polymer having a radiation-induced polymerizable unsaturated bond in a molecule, and a radiation-induced polymerizable polyfunctional oligomer or monomer.

The above-mentioned polymerizable polymer is obtained, for example, by previously synthesizing a (meth)acrylic polymer having a functional group in a molecule (hereinafter, referred to as a functional group-containing (meth)acrylic polymer) so as to be reacted with a compound having a functional group for reacting with the above-mentioned functional group and a radiation-induced polymerizable unsaturated bond in a molecule (hereinafter, referred to as a functional group-containing unsaturated compound).

The above-mentioned functional group-containing (meth)acrylic polymer, similar to the case of a general (meth)acrylic polymer as a polymer having adherence at normal temperature, is obtained by conventionally copolymerizing an acrylic alkyl ester and/or methacrylic alkyl ester as a main monomer, in which a carbon number of an alkyl group is typically in a range of 2 to 18, and a functional group-containing monomer and additionally, as required, another monomer for modifying copolymerizable therewith.

Examples of the above-mentioned functional group-containing monomer may include a carboxyl group-containing monomer such as acrylic acid and methacrylic acid; a hydroxyl group-containing monomer such as hydroxyethyl acrylate and hydroxyethyl methacrylate; an epoxy group-containing monomer such as glycidyl acrylate and glycidyl methacrylate; an isocyanato group-containing monomer such as isocyanatoethyl acrylate and isocyanatoethyl methacrylate; an amino group-containing monomer such as aminoethyl acrylate and aminoethyl methacrylate; and the like.

Examples of the above-mentioned another copolymerizable monomer for modifying may include various monomers used for a general (meth)acrylic polymer, such as vinyl acetate, acrylonitrile and styrene.

Examples of the above-mentioned functional group-containing unsaturated compound usable for being reacted with the functional group-containing (meth)acrylic polymer may include a compound similar to the above-mentioned functional group-containing monomer in accordance with a functional group of the above-mentioned functional group-containing (meth)acrylic polymer. For example, in the case where a functional group of the above-mentioned functional group-containing (meth)acrylic polymer is a carboxyl group, an epoxy group-containing monomer and an isocyanato group-containing monomer are used; in the case where the functional group is a hydroxyl group, an isocyanato group-containing monomer is used; in the case where the functional group is an epoxy group, a carboxyl group-containing monomer and an amide group-containing monomer such as acrylamide are used; and in the case where the functional group is an amino group, an epoxy group-containing monomer is used.

The weight-average molecular weight of the above-mentioned functional group-containing (meth)acrylic polymer is typically about 20 to 2,000,000.

The above-mentioned polyfunctional oligomer or monomer preferably has a molecular weight of 10,000 or less, and more preferably has a molecular weight of 5,000 or less and a radiation-induced polymerizable unsaturated bond number of 2 to 20 in a molecule so that the three-dimensional net working of a pressure-sensitive adhesive layer is efficiently performed by the irradiation of radioactive rays. Examples of such more preferable polyfunctional oligomer or monomer may include trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, and the like. Examples thereof may additionally include 1,4-butylene glycol di(meth)acrylate, 1,6-hexanediol di(meth)acrylate, polyethylene glycol di(meth)acrylate, commercially available oligoester (meth)acrylate, and the like. These polyfunctional oligomers or monomers may be used singly or together in two kinds or more.

The above-mentioned photo-curing adhesive resin comprises as an essential component the above-mentioned polymerizable polymer and the above-mentioned polyfunctional oligomer or monomer and, additionally, a photopolymerization initiator is preferably compounded therewith typically in using active light rays such as ultraviolet rays for polymerization and cure thereof.

An example of the above-mentioned photopolymerization initiator may include an initiator activated by being irradiated with light having a wavelength of 250 to 800 nm, and examples of such a photopolymerization initiator may include an acetophenone derivative compound such as methoxyacetophenone; a benzoin ether-based compound such as benzoin propyl ether and benzoin isobutyl ether; a ketal derivative compound such as benzyl dimethylketal and acetophenone diethylketal; a phosphine oxide derivative compound; and a photo-radical polymerization initiator such as a bis(η5-cyclopentadienyl)titanocene derivative compound, benzophenone, Michler's ketone, chlorothioxanthone, dodecylthioxanthone, dimethylthioxanthone, diethylthioxanthone, α-hydroxycyclohexyl phenyl ketone and 2-hydroxymethylphenylpropane. These photopolymerization initiators may be used singly or together in two kinds or more.

With regard to the above-mentioned photo-curing adhesive resin, the total adhesive resin is uniformly and promptly polymerized and crosslinked for integration by giving stimulation via light, whereby tan δ is notably decreased by polymerization and cure to remarkably decrease pressure-sensitive adhesive strength.

Examples of the above-mentioned adhesive substance such that tan δ is decreased by giving stimulation via an ultrasonic wave may include thermosetting adhesive resins such as a thermosetting adhesive, a thermosetting pressure-sensitive adhesive and a thermosetting sealing agent.

Examples of the above-mentioned substance such that tan δ is decreased by phase change from liquid matter to solid matter with the volatilization of a solvent may include adhesive resin for curing by the volatilization of a solvent, such as a solvent adhesive, a solvent pressure-sensitive adhesive and a solvent sealing agent.

Examples of the above-mentioned adhesive substance such that tan δ is decreased by passing electric current may include an adhesive substance having electrical conductivity and containing electroviscosity fluid, and the like. The passage of electric current via such an electrically-conductive adhesive substance aligns electroviscosity fluid component to decrease tan δ of the adhesive substance.

The above-mentioned resin having Tg in the vicinity of normal temperature is in a rubbery state of exhibiting a high viscoelasticity in the vicinity of normal temperature, and is made into a glassy state of decreasing tan δ when cooled below Tg, in which case, therefore, stimulation for decreasing tan δ is to cool.

The above-mentioned resin having Tg above normal temperature is not particularly limited, and examples thereof may include tacky acrylic resin and the like.

The above-mentioned adhesive substance may exhibit pressure-sensitive adhesive property at normal temperature or may not exhibit pressure-sensitive adhesive property at normal temperature at least before giving stimulation via an ultrasonic wave and/or impact or stimulation except the above-mentioned stimulation. The adhesive substance exhibiting pressure-sensitive adhesive property at normal temperature can preferably adhere immediately to a surface to adhere to.

The present invention is also directed to a method for peeling off an adhesive substance, which comprises giving stimulation to an adhesive substance containing a gas-generating agent for generating gas by giving stimulation via an ultrasonic wave and/or impact to generate gas from a gas-generating agent, and discharging generated gas to the outside of the adhesive substance of the present invention.

It is also preferable that stimulation is previously given to the adhesive substance so as to decrease tan δ before giving stimulation via an ultrasonic wave and/or impact. Thus, the adhesive substance can be easily peeled off.

The present invention is also directed to a connected structure, which is obtainable by bonding at least two or more adherends bonded together via an adhesive substance containing a gas-generating agent for generating gas by stimulation via an ultrasonic wave and/or impact.

### BEST MODE FOR CARRYING OUT THE INVENTION

The present invention will be further described hereinafter referring to examples; however, the present invention is not limited thereto.

### EXAMPLE 1

<Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl methacrylate was added to 100 parts by weight of resin solids content of the ethyl acetate solution containing the obtained acrylic copolymer so as to be reacted, and further 20 parts by weight of pentaerythritol triacrylate, 0.5 part by weight of benzophenone and 0.3 part by weight of polyisocyanate were mixed with 100 parts by weight of resin solids content of the reacted ethyl acetate solution to prepare the ethyl acetate solution of a pressure-sensitive adhesive (1).

| | | |
|---|---|---|
| butyl acrylate | 79 | parts by weight |
| ethyl acrylate | 15 | parts by weight |
| acrylic acid | 1 | part by weight |
| 2-hydroxyethyl acrylate | 5 | parts by weight |
| photopolymerization initiator | 0.2 | part by weight |
| (IRGACURE 651, | | |
| 50%-ethyl acetate solution) | | |
| lauryl mercaptan | 0.01 | part by weight |

100 parts by weight of 3-azide methyl-3-methyl oxetane was mixed with 100 parts by weight of resin solids content of the ethyl acetate solution of a pressure-sensitive adhesive (1) to prepare the ethyl acetate solution of a pressure-sensitive adhesive (2) containing an azide compound.

<Manufacture of Pressure-sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (1) by a doctor knife so as to have a dry film thickness of approximately 10 μm and dry the coating solution by volatilizing the solvent. The pressure-sensitive adhesive layer after being dried exhibited adherence in a dry state.

Meanwhile, a PET film having a thickness of 38 μm with release treatment on surfaces was coated with the ethyl acetate solution of a pressure-sensitive adhesive (2) by a bar coater so as to have a thickness of 5 μm after being dried and dry the pressure-sensitive adhesive layer by volatilizing the solvent.

The pressure-sensitive adhesive (1) layer formed on the PET film with corona treatment on one side and the pressure-sensitive adhesive (2) layer formed on the PET film with release treatment were bonded together and thereafter cured at a temperature of 40° C. for 3 days to obtain a pressure-sensitive adhesive tape 1.

<Peeling of Pressure-sensitive Adhesive Tape>

The obtained pressure-sensitive adhesive tape 1 was bonded on a quartz glass plate.

Ultrasonic waves were generated from the side of this quartz glass plate by an ultrasonic generator (manufactured by HONDA ELECTRONICS, SONAC-150) to observe many parts, in which the pressure-sensitive adhesive was peeled off the glass, on an adhesive interface via the glass. The pressure-sensitive adhesive tape was capable of being easily peeled off the glass plate.

### EXAMPLE 2

<Preparation of Adhesive Substance>

100 parts by weight of 2,2′-azobis-(N-butyl-2-methyl propionamide) was mixed with 100 parts by weight of resin solids content of the ethyl acetate solution of a pressure-sensitive adhesive (1) manufactured in Example 1 to prepare the ethyl acetate solution of a pressure-sensitive adhesive (3) containing an azo compound.

<Manufacture of Pressure-sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (1) by a doctor knife so as to have a dry film thickness of approximately 10 μm and dry the coating solution by volatilizing the solvent. The pressure-sensitive adhesive layer after being dried exhibited adherence in a dry state.

Meanwhile, a PET film having a thickness of 38 μm with release treatment on surfaces was coated with the ethyl acetate solution of a pressure-sensitive adhesive (3) by a bar coater so as to have a thickness of 5 μm after being dried and dry the pressure-sensitive adhesive layer by volatilizing the solvent.

The pressure-sensitive adhesive (1) layer formed on the PET film with corona treatment on one side and the pressure-sensitive adhesive (3) layer formed on the PET film with release treatment were bonded together and thereafter cured at a temperature of 40° C. for 3 days to obtain a pressure-sensitive adhesive tape 2.

<Peeling of Pressure-sensitive Adhesive Tape>

The obtained pressure-sensitive adhesive tape 2 was bonded on a quartz glass plate.

Ultrasonic waves were generated from the side of this quartz glass plate by an ultrasonic generator (manufactured by HONDA ELECTRONICS, SONAC-150) to observe many parts, in which the pressure-sensitive adhesive was peeled off the glass, on an adhesive interface via the glass. The pressure-sensitive adhesive tape was capable of being easily peeled off the glass plate.

### EXAMPLE 3

<Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl methacrylate was added to 100 parts by weight of resin solids content of the ethyl acetate solution containing the obtained acrylic copolymer so as to be reacted, and further 20 parts by weight of pentaerythritol triacrylate, 0.5 part by weight of a photopolymerization initiator (IRGACURE 819) and 0.3 part by weight of polyisocyanate were mixed with 100 parts by weight of resin solids content of the reacted ethyl acetate solution to prepare the ethyl acetate solution of a pressure-sensitive adhesive (4).

| | | |
|---|---|---|
| butyl acrylate | 79 | parts by weight |
| ethyl acrylate | 15 | parts by weight |
| acrylic acid | 1 | part by weight |
| 2-hydroxyethyl acrylate | 5 | parts by weight |
| photopolymerization initiator | 0.2 | part by weight |
| (IRGACURE 651, 50%-ethyl | | |
| acetate solution) | | |
| lauryl mercaptan | 0.01 | part by weight |

100 parts by weight of 3-azide methyl-3-methyl oxetane was mixed with 100 parts by weight of resin solids content of the ethyl acetate solution of a pressure-sensitive adhesive (4) to prepare the ethyl acetate solution of a pressure-sensitive adhesive (5) containing an azide compound.

<Manufacture of Pressure-sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (4) by a doctor knife so as to have a dry film thickness of approximately 10 μm and dry the coating solution by volatilizing the solvent. The pressure-sensitive adhesive layer after being dried exhibited adherence in a dry state.

Meanwhile, a PET film having a thickness of 38 μm with release treatment on surfaces was coated with the ethyl acetate solution of a pressure-sensitive adhesive (5) by a bar coater so as to have a thickness of 5 μm after being dried and dry the pressure-sensitive adhesive layer by volatilizing the solvent.

The pressure-sensitive adhesive (4) layer formed on the PET film with corona treatment on one side and the pressure-sensitive adhesive (5) layer formed on the PET film with release treatment were bonded together and thereafter cured at a temperature of 40° C. for 3 days to obtain a pressure-sensitive adhesive tape 3.

<Peeling of Pressure-sensitive Adhesive Tape>

The obtained pressure-sensitive adhesive tape 3 was bonded on a quartz glass plate.

The pressure-sensitive adhesive (4) layer and the pressure-sensitive adhesive (5) layer were irradiated with ultraviolet rays having a wavelength of 400 nm for polymerization and cure from the side of this quartz glass plate by using a metal halogen lamp with short-wavelength light cut out via a filter. Subsequently, ultrasonic waves were generated by an ultrasonic generator (manufactured by HONDA ELECTRONICS, SONAC-150) to observe many parts, in which the pressure-sensitive adhesive was peeled off the glass, on an adhesive interface via the glass. The pressure-sensitive adhesive tape was capable of being easily peeled off the glass plate.

### EXAMPLE 4

<Preparation of Adhesive Substance>

100 parts by weight of 2,2′-azobis-(N-butyl-2-methyl propionamide) was mixed with 100 parts by weight of resin solids content of the ethyl acetate solution of a pressure-sensitive adhesive (4) manufactured in Example 3 to prepare the ethyl acetate solution of a pressure-sensitive adhesive (6) containing an azo compound.

<Manufacture of Pressure-sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (4) by a doctor knife so as to have a dry film thickness of approximately 10 μm and dry the coating solution by volatilizing the solvent. The pressure-sensitive adhesive layer after being dried exhibited adherence in a dry state.

Meanwhile, a PET film having a thickness of 38 μm with release treatment on surfaces was coated with the ethyl acetate solution of a pressure-sensitive adhesive (6) by a bar coater so as to have a thickness of 5 μm after being dried and dry the pressure-sensitive adhesive layer by volatilizing the solvent.

The pressure-sensitive adhesive (4) layer formed on the PET film with corona treatment on one side and the pressure-sensitive adhesive (6) layer formed on the PET film with release treatment were bonded together and thereafter cured at a temperature of 40° C. for 3 days to obtain a pressure-sensitive adhesive tape 4.

<Peeling of Pressure-sensitive Adhesive Tape>

The obtained pressure-sensitive adhesive tape 4 was bonded on a quartz glass plate.

The pressure-sensitive adhesive (4) layer and the pressure-sensitive adhesive (6) layer were irradiated with ultraviolet rays having a wavelength of 400 nm for polymerization and cure from the side of this quartz glass plate by using a metal halogen lamp with short-wavelength light cut out via a filter. Subsequently, ultrasonic waves were generated by an ultrasonic generator (manufactured by HONDA ELECTRONICS, SONAC-150) to observe many parts, in which the pressure-sensitive adhesive was peeled off the glass, on an adhesive interface via the glass. The pressure-sensitive adhesive tape was capable of being easily peeled off the glass plate.

### INDUSTRIAL APPLICABILITY

The present invention can provide an adhesive substance capable of being easily peeled off without using light and damaging an adherend, and a method for peeling off the adhesive substance.

1. An adhesive substance,
which contains a gas-generating agent for generating gas by giving stimulation via an ultrasonic wave and/or impact thereto,
generated gas being discharged to the outside of the adhesive substance and discharged gas peeling part of an adhesive surface off an adherend.

2. The adhesive substance according to claim 1,
wherein tan δ is decreased by giving stimulation via an ultrasonic wave and/or impact or stimulation except said stimulation.

3. The adhesive substance according to claim 1,
which contains a component crosslinkable by giving stimulation via an ultrasonic wave and/or impact or stimulation except said stimulation.

4. The adhesive substance according to claim 1,
wherein a pressure-sensitive adhesive property is exhibited at normal temperature at least before giving stimulation via an ultrasonic wave and/or impact or stimulation except said stimulation.

5. The adhesive substance according to claim 1,
wherein a pressure-sensitive adhesive property is not exhibited at normal temperature.

6. A method for peeling off an adhesive substance,
which comprises giving stimulation to an adhesive substance containing a gas-generating agent for generating gas by giving stimulation via an ultrasonic wave and/or impact to generate gas from a gas-generating agent, and discharging generated gas to the outside of said adhesive substance.

7. A connected structure,
which is obtainable by bonding at least two or more adherends bonded together via an adhesive substance containing a gas-generating agent for generating gas by stimulation via an ultrasonic wave and/or impact.

8. The adhesive substance according to claim 2,
which contains a component crosslinkable by giving stimulation via an ultrasonic wave and/or impact or stimulation except said stimulation.

9. The adhesive substance according to claim 2,
wherein a pressure-sensitive adhesive property is exhibited at normal temperature at least before giving stimulation via an ultrasonic wave and/or impact or stimulation except said stimulation.

10. The adhesive substance according to claim 3,
wherein a pressure-sensitive adhesive property is exhibited at normal temperature at least before giving stimulation via an ultrasonic wave and/or impact or stimulation except said stimulation.

11. The adhesive substance according to claim 2,
wherein a pressure-sensitive adhesive property is not exhibited at normal temperature.

12. The adhesive substance according to claim 3,
wherein a pressure-sensitive adhesive property is not exhibited at normal temperature.
